(19) United States
(12) Patent Application Publication
(10) Pub. No.: US 2024/0211807 A1
(43) Pub. Date: Jun. 27, 2024

(54) INTERACTIVE DATA MODELING AND COMMUNICATION PLATFORM

(71) Applicant: Citizens Financial Group, Inc., Providence, RI (US)

(72) Inventors: Maggie Wall, Briarcliff Manor, NY (US); Christina Elizabeth Sweeny, Chadds Ford, PA (US); Julie Lazarus, Philadelphia, PA (US); Peter Charles Reiser, Southwick, MA (US)

(73) Assignee: Citizens Financial Group, Inc., Providence, RI (US)

(21) Appl. No.: 18/541,329

(22) Filed: Dec. 15, 2023

Related U.S. Application Data
(60) Provisional application No. 63/476,465, filed on Dec. 21, 2022.

(51) Int. Cl. G06N 20/00; G06F 9/451

(52) U.S. Cl. CPC G06N 20/00; G06F 9/451

(57) ABSTRACT

A novel system, method and computer program product are disclosed herein. The system may an interactive data modeling and communication platform (the “platform”) in communication with one or more user devices and external data systems. The platform may include one or more servers executing computer-readable instructions that cause the platform to perform operations such as generating and training machine learning models, receiving data and information relating to a plurality of users, converting the data and information into a suitable format for use by the machine learning models, and executing the machine learning models using the converted data and information as input. The machine learning models may generate user-personalized strategies and identify tools and resources for completing aspects of the user-personalized strategies. The operations may also include generating an interactive graphical user interface (GUI) that displays the user-personalized strategies and the tools and resources for completing aspects of the user-personalized strategies.

### CROSS REFERENCE

This application claims the benefit of priority under 35 U.S.C. § 119(e) to prior U.S. Provisional Patent Application No. 63/476,465, filed Dec. 21, 2022, the disclosure of which is incorporated by reference herein to its entirety.

### TECHNICAL FIELD

The present disclosure relates generally to electronic data and communication platforms, and more particularly, to an intelligent, interactive data modeling and communication platform that utilizes machine learning to develop user-personalized strategies, provide access to community data and interactions, and unlock/make available user-specific tools and resources for executing the user-personalized strategies.

### BACKGROUND

There currently does not exist a system or platform configured to leverage the power and information of community/ social networks and machine learning to generate dynamic user-personalized strategies that evolve over time. That is, existing systems lack the infrastructure and technology to integrate strategic planning modeling functionality with community interaction functionality, all within a single platform, a single program and/or a single interface. As a result, existing systems are incapable of leveraging community knowledge and interaction data to continually improve predictions and suggestions generated for users. Among other deficiencies, existing systems are also unable to: provide simultaneous access to information, tools, resources products and/or services that may be resident on disparate systems or platforms, all from a single platform, program and/or interface; connect and execute multi-party communications and/or multi-system interactions; and others.

As a result, there is a need for a new type of system, method and computer-program product that addresses the foregoing and other deficiencies in the art.

### SUMMARY

In some embodiments, a system is disclosed herein. The system may include one or more user devices, one or more external data systems and an interactive data modeling and communication platform (also referred to herein as the “platform”) that is in communication with the one or more user devices and the one or more external data systems via one or more communication networks. The platform may include one or more servers, each comprising one or more processors and a memory storing computer-readable instructions that, when executed by the one or more processors, cause the platform to perform operations. The operations may include generating and training one or more machine learning models, receiving, from among the one or more external data systems and the one or more user devices, data and information relating to a plurality of users, converting the data and information into a format that is suitable for use by one or more machine learning models, and executing the one or more machine learning models using the converted data and information as input. The one or more machine learning models may be configured to generate, for at least one among the plurality of users, a user-personalized strategy, and identify one or more tools and resources for completing one or more aspects of the user-personalized strategy.

The operations may also include generating an interactive graphical user interface (GUI) that displays the user-personalized strategy and the one or more tools and resources for completing the one or more aspects of the user-personalized strategy.

Further, the operations may include monitoring at least one among the one or more external data systems and the one or more user device for changes to the data and information, re-executing the one or more machine learning models responsive to the monitored data and information and dynamically updating the interactive GUI to display changes to the user-personalized strategy and the one or more tools and resources resulting from said re-executing.

In some embodiments, a method is disclosed herein. The method may be executed by a system comprising one or more servers, each comprising one or more processors and a memory storing computer-readable instructions that, when executed by the one or more processors, cause the platform to perform the method. The method may include generating and training one or more machine learning models, receiving, from among the one or more external data systems and the one or more user devices, data and information relating to a plurality of users, converting the data and information into a format that is suitable for use by one or more machine learning models, and executing the one or more machine learning models using the converted data and information as input.

The method may also include generating, by one or more machine learning models for at least one among the plurality of users, a user-personalized strategy, and identifying one or more tools and resources for completing one or more aspects of the user-personalized strategy.

The method may also include generating an interactive graphical user interface (GUI) that displays the user-personalized strategy and the one or more tools and resources for completing the one or more aspects of the user-personalized strategy.

Further, the method may include monitoring at least one among the one or more external data systems and the one or more user device for changes to the data and information, re-executing the one or more machine learning models responsive to the monitored data and information and dynamically updating the interactive GUI to display changes to the user-personalized strategy and the one or more tools and resources resulting from said re-executing.

In some embodiments, a computer program product is disclosed herein. The computer program product may include computer-readable instructions that, when executed by one or more processors, cause a computer system to perform operations. The operations may include generating and training one or more machine learning models, receiving, from among the one or more external data systems and the one or more user devices, data and information relating to a plurality of users, converting the data and information into a format that is suitable for use by one or more machine learning models, and executing the one or more machine learning models using the converted data and information as input. The operations may further include generating, for at least one among the plurality of users, a user-personalized strategy, and identify one or more tools and resources for completing one or more aspects of the user-personalized strategy.

The operations may also include generating an interactive graphical user interface (GUI) that displays the user-personalized strategy and the one or more tools and resources for completing the one or more aspects of the user-personalized strategy.

Further, the operations may include monitoring at least one among the one or more external data systems and the one or more user device for changes to the data and information, re-executing the one or more machine learning models responsive to the monitored data and information and dynamically updating the interactive GUI to display changes to the user-personalized strategy and the one or more tools and resources resulting from said re-executing.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram of an exemplary computing system, in accordance with some exemplary embodiments described herein.

FIGS. 2A-2D show exemplary screens of an interactive graphical user interface (GUI), in accordance with some exemplary embodiments described herein.

FIG. 3A-3F show exemplary screens of an interactive GUI associated with a user experience (UX) according to the present disclosure.

FIG. 4 is a flow chart of an exemplary method, in accordance with some exemplary embodiments.

FIG. 5 is a block diagram of a machine, in accordance with some exemplary embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure relates generally to systems, methods and computer program products for leveraging multiple, independent systems, data sources and computer program logic for providing an interactive data modeling and communication platform that utilizes machine learning to develop user-personalized strategies, provide access to community data and interactions, and unlock/make available (or lock/make unavailable) user-specific planning tools and resources for executing the user-personalized strategies. In some aspects, the user-personalized strategies may comprise a combination of ‘bite-sized’ action items that, if completed, may result in fulfillment of said user-personalized strategies. ‘Bite-sized’ action items may include action items, to be executed and/or initiated by a user, that are routine, easy to understand, easy to implement, have a small time commitment and/or are otherwise easily achievable. The access to community data and interactions may also be determined intelligently and strategically by one or more adaptive machine learning models that takes into account a user's own data profile, the data profile of other uses sharing similar characteristics, live and/or historic data indicative of user interactions within an online community environment, and/or a combination of any other parameters or characteristics that may impact the relevance of the community data and interactions to the user.

For each user, as any of the data or information from the independent systems or data sources changes, as the user completes aspects of his/her user-personalized strategy, as the user's community interactions change, as the platform's planning tools and/or resources become available or evolve, as the user's own tendencies within the platform and/or in connection with external platforms change (e.g., as determined via machine learning models), etc., aspects of the user-personalized strategy (e.g., removal of existing and/or addition of new user-personalized action items or recommendations), the user's profile, the community data and interactions, platform-generated alerts, predictions, insights, suggestions, etc., and the planning tools and resources made available (and/or unavailable) by the platform may also change, so as to continually provide each user with a customized, up-to-date interaction experience that reflects then-current data and information.

The present disclosure also relates to a dynamic, interactive graphical user interface (GUI) through which users may access and interact with the user-personalized strategies, the community data and interactions, and the planning tools and resources made available by the platform. Users may access the platform using any type of computing device (e.g., laptop computer, palm PC, desktop or workstation computer, tablet computer, network server, mainframe computer, etc.) via a downloadable computer software program or application, or directly online as a cloud-based service (e.g., a subscription-based software as a service). In some examples, users may access the platform of this disclosure and/or certain features and functions thereof, on a subscription basis, where different subscription levels provide different levels of access to the platform.

Existing systems in the art are incapable of providing the type of integrated, machine-learning-based technology described herein because of their many technological deficiencies. Such deficiencies include (among other): an inability to access and procure data from disparate data sources and repositories in a system-resource efficient manner; an inability to capture and model all types of user interaction data (from both internal and external systems and sources) to intelligently predict and efficiently obtain user-specific data and information; an inability to recognize and respond to user tendencies; an inability to integrate strategic planning functionality with community interaction functionality, all within a single program via a single interface; an inability to develop user-personalized strategy plans comprised of ‘bite-sized’ modular action items that may be facilitated through a single system; an ability to leverage community knowledge and interaction data to continually improve predictions and suggestions to a user; an inability to provide simultaneous access to information, tools, resources products and/or services that may be resident on disparate systems; a lack of connectivity and integration for executing multi-party communications and/or multi-system interactions; an inability of system and/or interactive GUI's to automatically evolve in accordance with changes in user profile data, profile data of other users, user tendencies, disposition of user-personalized strategy, etc.; and others.

Having recognized the foregoing (and other) deficiencies, the present disclosure provides a new type of platform having a new intuitive, interactive GUI that represents significant technological advancements over any system in existence. Indeed, the Applicant has developed a new, continually-learning platform and interactive GUI that provide a combination of personalized planning tools, knowledge base resources, community learning and user interactions that are particular to, and evolves with, each user and/or each community of users. Not only does this platform develop a personalized strategy for each user, but it defines the strategy as a combination of modular (e.g., ‘bite-size’) tasks that may be facilitated directly through the platform. In addition, the platform intelligently integrates strategic planning and resource functionality and availability with social/community networking and interaction capabilities, all in a single place. To be clear, the platform does not just provide access to social/community networking interactions; to the contrary, the platform utilizes machine learning modeling to leverage data and information obtained and extracted from the community interactions (of individual users and/or communities of users) to identify and provide access to strategic planning and resource tools (e.g., functions, routines, software programs, etc.), service offerings, recommendations, predictions, and/or knowledge base resources, etc., as further discussed below. For purposes of this disclosure, knowledge base resources may include (without limit) any source or type of data and information (e.g., articles, platform-side user interactions, personalized advice, instructional videos, publications, web-based content, etc.), whether provided directly by the platform and/or indirectly from any number of external data/information sources.

In addition, the platform described herein may leverage community interaction data and/or other data associated with individual users and/or communities of users to continually assess (e.g., via machine learning modeling) the effectiveness, resonance, accuracy, impact, utilization, and/or any other attributes of the platform-provided recommendations, tools, knowledge base resources, etc. The platform's continual learning and assessment also enables the platform (and its recommendations, resources, etc.) to improve and evolve with the interests and needs of users. In this regard, the platform represents a new technological paradigm, one in which social/community networking is transformed from a mere tool for interactions between various users, into one that may be integrated with and serve as a basis for continually learning about the users (both individually and as a community), and in turn, continually improve, update, procure, and/or make available tools and knowledge base resources that are particularly relevant to, and may be driven and directed by, each particular user. The platform's continual learning also enables the platform to update and improve the very social networks within which users interact.

Notably, the innovations described herein are not limited to any particular field or industry. To the contrary, the interactive data modeling and communication platform and other innovations described herein may be configured for use in any field or industry desiring to (among other things) intelligently leverage social/community interaction data to develop, improve and provide access to user-specific recommendations, tools, resources, etc. It should also be noted that the platform and other innovations described herein may be particularly useful in industries that have limited access to information about its users, and for users that otherwise may not have access to tools and/or resources of certain industries. As a result, the present disclosure not only describes a technological advancement, it also provides tools for addressing knowledge, information and/or access deficits amongst groups or classes of users. Indeed, the platform and other innovations described herein enables all types of users to learn, plan and evolve in a self-directed manner and by leveraging community knowledge and resources.

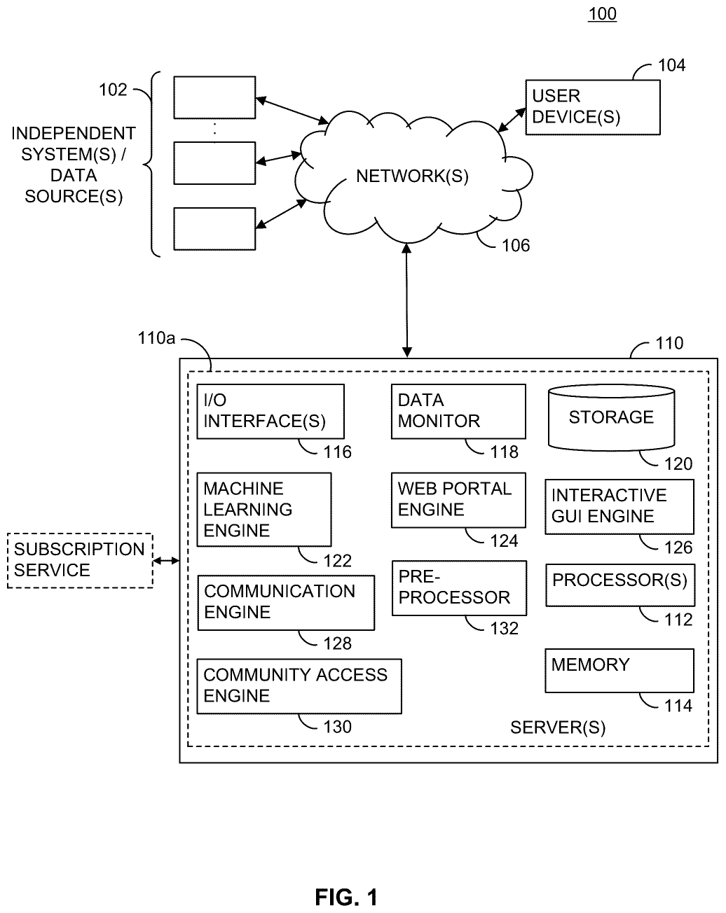

Turning now to FIG. 1, an exemplary system 100 comprising an exemplary interactive data modeling and communication platform 100 according to the present disclosure is shown (also referred to herein as “the platform”). The platform 110 may include one or more servers 110a executing computer program logic (e.g., computer-readable instructions) for integrating and linking multiple independent systems and/or data sources (collectively, the “external data systems”) 102, monitoring and extracting data and information therefrom, and executing one or more machine learning models to develop user-personalized strategies, provide personalized access to community data and interactions, and unlock/make available (or lock/make unavailable, as needed) user-specific planning tools and resources (e.g., including personalized advice, suggestions, predictions, interactions with platform-side users, etc.) for executing the user-personalized strategies. Although the platform 110 is shown having a single server 110a, which may be referred to herein as simply “the platform server 110a,” it should be understood that the platform 110 may include any number of servers 110a, whether co-located or linked across one or more networks. Further, it should be understood that the platform server 110a may include at least one processor 112 and non-transitory memory 114 storing computer-readable instructions defining one or more software modules or engines, one or more routines and/or algorithms (e.g., machine learning algorithms/models) for performing the functions of the platform server(s) 110a described herein. The one or more software modules, engines, routines, and/or algorithms described herein may comprise collections of code or computer-readable instructions stored on a media (e.g., memory 112 of platform 110) that represent a series of machine instructions (e.g., program code) that implements one or more steps, features and/or operations. Such machine instructions may be the actual computer code the processor 112 of the platform 110 interprets to implement the instructions or, alternatively, may be a higher level of coding of the instructions that is interpreted to obtain the actual computer code. The one or more software modules, engines, routines and/or algorithms may also include one or more hardware components. One or more aspects of an example routine or algorithm may be performed by the hardware components (e.g., circuitry) itself, rather as a result of the instructions.

As shown, the platform 110 may be communicatively coupled to one or more external data systems 102, and one or more user devices 104 via one or more communication networks 106. The communications network(s) 106 may include, for example, a private network (e.g., a local area network (LAN), a wide area network (WAN), intranet, etc.) and/or a public network (e.g., the Internet).

The one or more external data systems 102 may each comprise at least one computing device (e.g., a server computer, a desktop computer, a laptop computer, a smartphone, a tablet, etc.) executing computer-readable instructions to capture, receive, store and/or disseminate data and information. Such data and information may include historic and/or current (e.g., real-time) data and information specific to each of a plurality of users, such as each user's geolocation, electronic account(s) information, credit score data, purchase activity data, etc., and/or data that may be relevant to, but not specific to, said users (e.g., market data, interest rates, etc.). Examples of external data systems 102 may include (without limit) point-of-sale (POS) systems, financial institution systems (e.g., a bank entity, a loan service, etc.), business entity systems (such as a utility company, a telecommunications company, etc.), government entity systems (e.g., federal agencies, state government agencies, etc.), credit agency systems, other users/systems, and/or any suitable source of data and/or information.

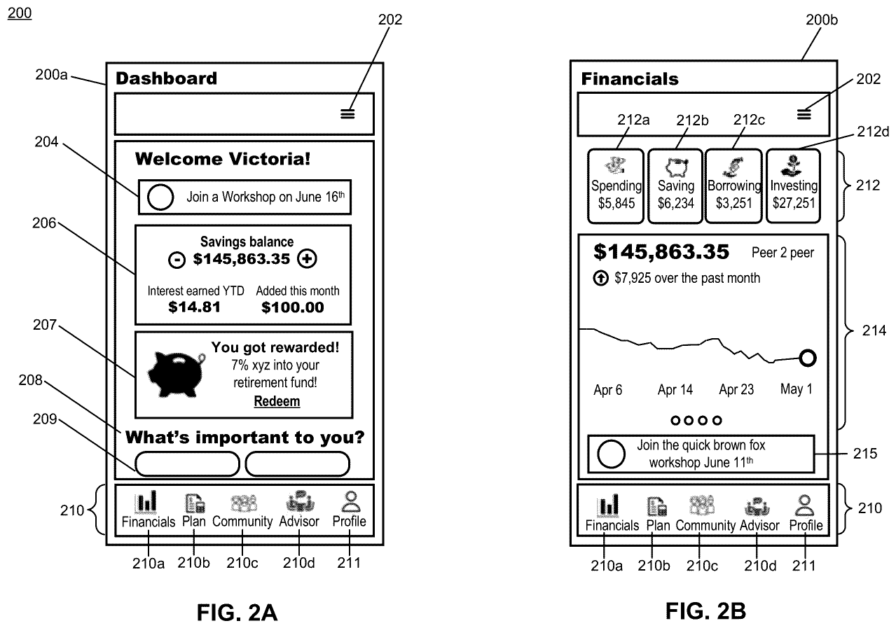

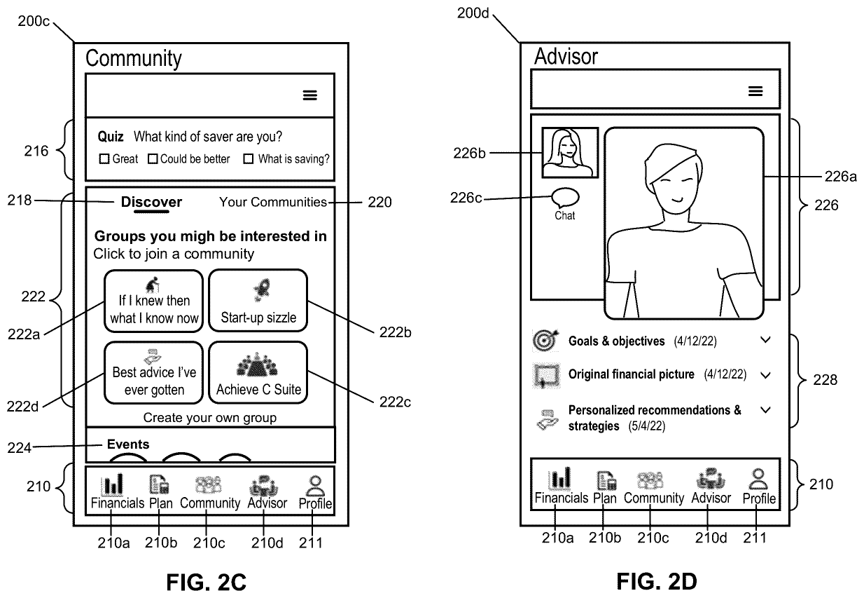

The user device(s) 104 may include, without limit, any combination of mobile and/or stationary communication devices such as mobile phones, smart phones, tablets computers, laptop computers, desktop computers, server computers or any other computing device configured to capture, receive, store, render, display and/or disseminate data. The user device(s) 104 may include a non-transitory memory, one or more processors executing computer-readable instructions, a communications interface which may be used to communicate with the platform server 110a, a user input interface for inputting data and/or information to the user device(s) 104 and/or a user display interface for presenting data and/or information on user device(s) 104. In some examples, the user input interface and the user display interface may be configured as an interactive graphical user interface (GUI) (such as the exemplary interactive GUI shown in FIG. 2, discussed below). The user device(s) 104 may also be configured to display an interactive GUI generated and/or rendered by the platform server 110a.

In some embodiments, the user device(s) 104 may include at least one software application (not shown). The software application may be representative of a web browser that provides access to a website or a stand-alone application. User device(s) 104 may invoke the software application to access one or more functionalities of platform 110. For example, the user device(s) 104 may be configured to execute the software application to access, generate and/or manage user-personalized strategies, forecasts, alerts, etc. pertaining to a user's account, as generated by the platform 110. Content that is displayed on the user device 104 may be transmitted from the platform 110 to the user device(s) 104, and subsequently processed by the software application for display via a graphical user interface (GUI).

The platform server 110a may include one or more input and/or output interfaces (collectively referred to herein as I/O interface(s)) 116, a data monitor engine 118, storage 120, a machine learning modeling engine 122, a web portal engine 124, an interactive GUI engine 126, a communication engine 128, a community access engine 130, a pre-processor 132, and other components (not shown). In some examples, the platform server 110a may include one or more software applications. Components of the platform server 110a may communicate with each other via a data and control bus (not shown), and each such component may include a processor, a microcontroller, a circuit, and/or other hardware component(s) executing software (e.g., computer-readable instructions defining routines, processes, etc.) for performing its respective functions.

The platform server 110a may obtain data and/or information from among the external data systems 102 and/or user devices 104 via the input/output (I/O) interface(s) 116. The platform server 110a may also include one or more application program interfaces (APIs), now shown, for exchanging data and information among applications and devices/components within and external to the platform server 110a. Data and information from the external data systems 102 may be obtained through one or more live data feeds, one or more file transfers (including, in some examples, one or more secure file transfers), by data being pushed to platform server 110a and/or by the platform server 110a pulling and/or extracting data and/or information from among the external data systems 102.

Data and information may also be obtained from the user devices 104 as a result of user input and/or other interactions with said user devices 104, or extracted automatically from user device memory.

In some examples, the platform server 110a may filter, parse and/or aggregate the obtained data (e.g., via the pre-processor 132), so as to retain and process relevant data to improve the system's overall modeling accuracy and efficiency, while purging and discarding irrelevant, redundant and/or biased data and information. In some examples, the platform server 110a may implement one or more security protection protocols to protect the integrity of the obtained data and information.

The platform storage 120 may comprise memory, one or more databases, etc. for storing data and/or information associated with the various functions of the platform server 110a. Such storage 120 may further be configured to store user and/or data profiles associated with users, data from internal electronic accounts (e.g., electronic accounts associated with and/or maintained by the platform 110), data from external electronic accounts (e.g., electronic accounts associated with and/or maintained by one or more of the external data systems 102), user activity data, machine learning modeling output (e.g., predictions, proposed user-specific strategies, suggestions, etc.) and/or data and information of any other type from any other source. In some instances, certain users may be associated with a combination of internal and external electronic accounts. In those instances, the platform 110 may be configured to link each user's associated accounts, and aggregate said data for purposes of modeling, predicting, making recommendations, generating alerts, etc. (as further discussed below). The storage 120 may also be configured to store parameters, functions and/or other information that may be useful for executing, improving and/or updating any components of the platform 110 (e.g., training the platform's machine learning models).

The data monitor engine 118 may be configured to monitor data and information collected from among the external data systems 102 and/or user devices 104 to detect changes to the data and information, or the presence of new data and information. The data monitor may also be configured to monitor user activity and/or interactions with various components of the platform 110 including, for example, community interactions (e.g., conversations, messages, clicked links, etc.) made available via the community access engine 130, discussed below). In some examples, the data monitor may detect user activity and/or other interaction data (and/or changes thereto) that meet one or more predetermined criteria, which may in turn be provided to one or more other components of the platform 110, such as the machine learning modeling engine 122 (discussed below), for further processing. In some examples, the data monitor engine 118 may be configured to continuously and/or periodically monitor any of the data and information mentioned above.

The machine learning modeling engine 122 may be configured to receive data and information from the data monitor engine 118, from among the external data systems 102 and user devices 104, and directly from the platform 110 itself (e.g., storage 120). This data and information may include historical, current (real-time) and/or predicted data (e.g., output from prior run models/algorithms), and may include data and information associated with multiple users (e.g., users having similar profiles). The machine learning modeling engine 122 may then use this data and information to train, execute and/or update one or more machine learning models/algorithms to achieve one or more objectives.

Output of the machine learning models/ algorithms may be used to create, manage and/or dynamically update user profiles, user-personalized strategies, alerts, predictions, insights, suggestions, user-specific community interaction groups/activities, etc. In some embodiments, the platform 110 may be configured to retrieve, from one or more data sources among the external data systems, user-personalized information and content based on the output of the machine learning models/algorithms.

In some embodiments, output of one or more machine learning models/algorithms may be used as input to one or more other machine learning models/algorithms, wherein based on said input, the one or more other machine learning models/algorithms may dynamically update user profiles, user-personalized strategies, alerts, etc. In some examples, the machine learning models/algorithms may be automatically initiated upon detection of any changes to any of the data and information that may impact prior modeling output, and the machine learning models/algorithms may automatically be updated as a result of back-testing initiated by the platform server 110a. In some embodiments, detecting such changes may include comparing current data and information (e.g., collected and/or monitored in real-time) to previously collected/monitored data and information, and evaluating the comparison against one or more predetermined threshold parameters. Comparisons that meeting or exceeding the one or more predetermined threshold parameters may then trigger re-execution of one or more of the machine learning models/algorithms.

In some embodiments, the machine learning modeling engine 122 may be configured to deploy multiple machine learning models/algorithms at or near a same time, to enable the multiple learning models/algorithms to operate concurrently and cooperatively. For example, output from a first machine learning model may be utilized as input for a second machine learning model to generate new and/or updated output from said second machine learning model.

In some embodiments, the machine learning modeling engine 122 may train and deploy (e.g., execute) one or more machine learning models to achieve various and/or interrelated objectives (e.g., generate, manage and/or update user-personalized strategies, suggested tools and resources for executing user-personalized strategies, user activity predictions, community interaction predictions and recommendations, etc.). Depending on the particular objective, the machine learning modeling engine 122 may utilize any among various types and combinations of algorithms.

To train the one or more machine learning models, the machine learning modeling engine 122 may, for each machine learning model, collect, receive and/or extract historical and/or current (real-time) data and information from one or more data sources (e.g., external data systems 102, user devices 104, data monitor engine 118, platform storage 120, etc.). The data and information may also include data and information generated by one or more other machine learning models, as noted above. The types of data and information collected may include user profile data of one or more users, prior user-personalized strategies, user interaction data, user behavioral activity data, account data, market data, and other relevant data and information.

This data and information may then be pre-processed (e.g., by the pre-processor 132), which may include (among others) removing noise (e.g., duplicates, corrupted data, etc.), resolving missing data values, filtering, normalizing, scaling, augment (e.g., to add labels and additional data types), and the like. In some embodiments, the pre-processing may include filtering and/or weighting the data and information to emphasize activity and data indicative of successfully completing user-personalized strategies, objectives thereof, or other tasks (even if not a part of a stated objective or strategy). For example, user interaction data and/or user behavioral activity data associated with users that accomplished certain tasks (e.g., reached a savings balance, achieved a particular portfolio diversification, reduced overall account debt by X %, etc.), even if such tasks were not a part of a formal or system-generated user-personalized strategy, may be weighted more favorably than other user interaction data and/or behavioral activity data that failed to accomplish or achieve any such tasks. In some embodiments, accomplishing certain tasks may be weighted even more favorably than accomplishing other tasks.

In some aspects, the pre-processor 132 may convert the data and information into a format that the machine learning model(s) can understand and utilize effectively. In some embodiments, the pre-processor 132 may be a part of the machine learning modeling engine 122, while in other embodiments the pre-processor 132 may be independent from (but in communication with) the machine learning modeling engine 122.

Once the data and information is pre-processed, the machine learning modeling engine 122 may utilize the data and information to train a respective machine learning model. The training may include splitting the pre-processed data and information into multiple data sets, each data set for use in training, validating and/or testing the respective machine learning model.

During training, the one or more machine learning models may, based on a respective set of training data, identify patterns and relationships in the data and information by solving one or more objective functions, where each objective function may comprise one or more parameters (e.g., weight). The patterns and relationships identified during training may include, for example, user tendencies, interdependencies between variables, user sentiment (e.g., to suggested actions, strategic plans, community interactions, predictions, tools, resources, etc.), user preferences, and the like.

Also during training, the machine learning modeling engine 122 may measure a performance of each machine learning model, using a validation data set, based on one or more performance metrics. The performance metrics may include, for example, accuracy, profit, or any other relevant measure of success. If the measured performance is unsatisfactory, one or more of the parameters may be adjusted and the performance re-measured. This process may be iterative and continue until the performance is deemed satisfactory (e.g., meets or exceeds the one or more performance metrics).

Following training and prior to deployment, each machine learning model may be tested to determine its effectiveness. In the case of a personalized strategy model, for example, the trained model may be applied to a simulated environment and/or data set, and its effectiveness measured against one or more scenarios.

The one or more machine learning models may then be deployed to generate, retrieve and/or dynamically update and improve, based on input, user-personalized strategies, user profiles, alerts, predictions, automated decision making, recommendations (e.g., as to tools, resources, community interactions, etc.), user-personalized content and information (e.g., from one or more data sources) and so on, which may then be presented (including simultaneously) via an interactive GUI on a user device 104. The user-personalized strategies, user profiles, alerts, predictions, etc. may be interactive, insofar as a user may select, reject, update, delete, etc., via the interactive GUI, any of said strategies, user profiles, alerts, predictions, etc.

As noted above, deployment of the one or more machine learning models may be automatic (e.g., in response to receiving input, upon detecting changes in data, upon detecting certain user interactions, etc.) and/or according to a predetermined schedule. In some embodiments, the platform 110 may prompt/request input, for example, by generating and displaying one or more prompts on an interactive GUI displayed on a user device 104. Input to the one or more machine learning models may include, without limit, real-time (current) and historic data and information from among the external data systems 102 and user devices 104, directly from the platform 110 itself (e.g., monitored interactions, from storage 120, etc.), output from among the one or more machine learning algorithms, and so on. In some embodiments, the input may itself be pre-processed to remove noise (e.g., duplicates, corrupted data, etc.), resolve missing data values, filter, normalize, scale, and/or augment data included in the input (e.g., to add labels and additional data types), and the like, prior to deployment of the one or more machine learning models.

In some embodiments, performance of the one or more machine learning models, once deployed, may be evaluated over time. Then, depending on the performance evaluation, the machine learning modeling engine 122 may update and/or retrain one or more of the machine learning models. The performance of the one or more machine learning models may be a measure of accuracy of predictions, user sentiment (e.g., of proposed strategies, interactions, etc.), a utilization rate (e.g., of suggested tools and resources), etc.

In some embodiments, the machine learning modeling engine 122 may be configured to train and deploy one or more machine learning models to identify, learn and output one or more behavior patterns (e.g., tendencies) and/or preferences of a particular user, and then use the learned patterns and preferences as input to one or more other machine learning models to improve the personalized strategies, alerts, predictions, etc. for that particular user. Notably, the data and information used to identify and learn a user's patterns and preferences may include historic, current and/or predicted data and information from among one or more other users (e.g., user profiles and/or behavior patterns of users sharing similar profile characteristics).

The communication engine 128 of the platform 110 may be configured to generate and transmit user-specific communications (e.g., updated user profile data, user-personalized strategies, alerts, predictions, insights, suggestions, user-specific community interaction groups/activities, etc.) based on output and/or instructions from the machine learning modeling engine 122. These communications may, in turn, be displayed to users via the user devices 104.

The community access engine 130 may be configured to intelligently (e.g., based on modeling output from one or more machine learning models of the machine learning modeling engine 122) suggest and/or provide access to one or more community/social networking groups, where members of such groups may have one or more characteristics, interests, tendencies, etc. in common, and/or where the community access engine 130 determines (notwithstanding having common characteristics, interests, etc.) that one or more users may benefit from involvement in/interactions with one or more community/social networking groups. Access to such groups enables users to share and display content, comment on content, and communicate in any number of ways (text, video, etc.) via the interactive GUI displayed on a user device 104. In some embodiments, the interactive GUI may include one or more community interaction regions specifically configured to provide interactive access to the one or more community/social networking groups on a same graphical display on which other user-specific suggestions, predictions, tools, strategic plans, etc. are being displayed. In this manner, users may enjoy live/active interactions with community/social networking groups, while at the same time view the effects and/or impacts of such interactions on other information being modeled and displayed (e.g., user-specific suggestions, predictions, tools, strategic plans, etc.), in real-time or near real-time. For example, user interactions in a particular social networking group (e.g., clicked links, submitted text, etc.) may be captured (e.g., by data monitor 118) and modeled (e.g., via machine learning modeling engine 122) as the user interactions are occurring, and results of the modeling (e.g., changes to recommendations, changes to a user's personalized strategic plan, etc.) may be incorporated into the interactive GUI, also while the user interactions are still occurring.

Data and information obtained from such community group interactions (e.g., conversations, messages, clicked links, negative/positive/neutral reactions (e.g., liking a post), reactive posts, comments, etc.) may then be leveraged to improve the machine learning modeling algorithms and output. This may involve, for example, monitoring and capturing the data and information (e.g., by the data monitor 118) from the community group interactions, implementing a data recognizer (not shown) to identify and classify the various types of interactions within and/or relating to the community group(s), a data convertor (not shown) to convert the interactions into data suitable for processing by the machine learning modeling engine 122, (e.g., creating training data) and updating/executing the machine learning algorithms/models using the interaction data extracted from the community group interactions. Output from the algorithms/models may then be used to update and improve the user-personalized strategies, predictions, suggestions, recommended tools, knowledge base resources, recommended community groups, etc.

In a non-limiting example, output from the machine learning algorithms/models described above may be cross referenced against a particular user's strategic plan, and used to drive content, recommendations, tools, resources, etc. to that particular user. Since the content, recommendations, tools, etc. were intelligently modeled, they may be both useful for advancing the particular user's strategic plan, and also likely to be utilized by the particular user. The output may also be utilized to recommend additional or alternative community group(s) for the particular user to join. Further still, use (or lack thereof) of the content, recommendations, tools, resources, etc. by the particular user may be further modeled to improve future content, recommendations, tools, etc. made available by the platform 110.

The interactive GUI engine 126 of the platform 110 may be configured to generate one or more dynamic, interactive graphical interfaces (GUIs) for display on one or more devices (e.g., user device(s) 104). In some embodiments, the interactive GUI engine 126 may be configured to generate an interactive GUI having a uniquely configured arrangement of one or more user input regions, one or more notification (e.g., alert) indication(s) regions, one or more display regions, and one or more community interaction regions. In some examples, one or more portions of interactive GUI may be automatically updated (including in real-time or near real-time) responsive to changes in information and data (e.g., as determined by the machine learning modeling engine 122, based on monitored data, learned user tendencies/preferences, etc.). The interactive GUI may also be configured to permit and prompt user input, which in turn may automatically cause information being displayed on the interactive GUI to be updated in response to the user input. Example screens of an exemplary interactive GUI are shown in FIG. 2. In some embodiments, interactive GUI engine 126 may transmit the interactive GUIs to the one or more devices, such as user device(s) 104, for rendering and display thereon. In some embodiments, interactive GUI engine 126 may render the interactive GUIs at the platform server 110a, and transmit the rendered interactive GUIs to the user device(s) 104 for display thereon.

User input into an interactive GUI (e.g., via user device 104) may trigger one or more processing functions by the platform server 110a. This may include, for example, initiating the machine learning modeling engine 122 to update the user-personalized strategy and/or available planning tools or resources based on a change in user data input via the interactive GUI. The interactive GUI may also display updates resulting from automated processing functions initiated without any user input whatsoever. This may include, for example, a change in a user's credit score (e.g., retrieved from one or more external data systems 102) causing the platform server 110a to update available products and/or tools for advancing the user-personalized strategy. The interactive GUI may further be configured to display one or more automated notification indications (e.g., generated by the communication engine 128) that may be shown via the user devices 104. In some examples, the automated notification indications may include predictive behavior-based suggestions (e.g., “you may be interested in connecting with a new community group”; “your activity in December requires an adjustment to January's strategic actions”, etc.).

In some examples, the interactive GUI engine 126 may be configured to prepopulate one or more portions of an interactive GUI with information particular to a user, for example, based on the particular user's prior interactions with the platform 110 and/or based on data stored or obtained by the platform 110. In other examples, one or more portions of the information may be manually entered (e.g., via a user device 104) or automatically updated from electronic accounts accessible by the platform 110, in real or near real time.

The interactive GUI engine 126 may be configured to generate a presentation of various types of information, various quantities of information aggregated from the multiple external data systems 102 and/or various functions accessible via a display screen of user devices 104. For example, interactive GUI engine 126 may be configured to generate an interactive GUI that provides a simultaneous display of multiple accounts, live updates to user-personalized strategies, live suggestions, live communication interactions, etc. In some examples, the platform server may connect to one or more external data systems 102 that house banking accounts, credit card accounts, credit bureau data, live market data, etc. (e.g., government entity systems, private entity systems, etc.) to generate presentations of such information on a user-specific interactive GUI display.

In operation, a user may access the platform 110 of the present disclosure by downloading, installing and launching a software application directly from the user's device. In some embodiments, the user may access the platform 110 online, as a cloud-based service (e.g., a subscription-based software as a service). Upon accessing the platform 110, the user may be presented with an interactive dashboard. In some embodiments, the use may access features and functions of the platform 110 via a web portal (e.g., generated by the platform's web portal engine 124) that provides user-personalized information, content, features, etc. The level, type and amount of user-personalized information, content, features, etc. available through the web portal may be based on the user's subscription level.

If the user is a new user, the dashboard may present the new user with a series of basic questions. Responses to these basic questions may be used to develop an initial profile of the user. The type of data collected in response to the basic questions may include, for example, personal identifiable information, demographic data, financial data, user-defined interests, objectives and/or goals, etc.

If the user is a returning user (e.g., the use has previously established an account within the platform 110 and/or has provided responses to the basic questions during a prior interaction), the dashboard may present updates, notices, recommendations, and/or other information relating to the returning users' account(s), personalized strategy, community activity, etc.

In some aspects, the platform 110 may use machine learning modeling to continually improve and/or update the basic questions presented to users, so as to obtain the most relevant and impactful data for purposes of predicting and/or suggesting user tendencies, objectives, etc. For example, the platform 110 may determine, based on machine learning modeling, which are the most relevant and predictive data associated with the platform's users. The platform 110 may then use this information to update the basic questions, so as to better and more accurately solicit the most relevant and predictive data. In this manner, each new user may be presented with the latest version of the basic questions. The platform 110 may also, from time to time, present existing users with updated basic questions.

Responses to the basic questions may then be combined with other data from one or more other sources and fed into the platform's machine learning modeling engine 122 to develop a user profile. The one or more other data sources may include internal data sources and external data sources. Internal data sources may include the platform 110 itself and/or other associated systems, and may provide (without limit) data such as existing user account data (e.g., user balance(s), spending habits, etc.), historical platform interaction data (e.g., community interactions, etc.), previously implemented personalized strategy data, prediction data, profile data of one or more other users, etc.

External data sources may include one or more independent (third party) systems and/or data sources such as (without limit) government systems, public records, market data sources, credit agencies, user-owned accounts from other entity systems, etc.

In some embodiments, the user's profile may be dynamic, insofar as the platform 110 may be configured to continuously (or periodically) monitor both internal and external data sources, and re-execute one or more machine learning modeling algorithms to account for any changes to the data obtained therefrom. In some aspects, only those changes determined (e.g., via modeling) to impact one or more of the user's personalized strategy, recommendations, notices, etc. may trigger re-execution of the one or more machine learning modeling algorithms.

The platform 110 may then implement further machine learning modeling algorithm(s) to develop a dynamic, user-personalized strategy for the user, as well as to determine, suggest, and/or make available options, products, services, tools, resources (e.g., system-side users, knowledge database, etc.), etc. for carrying out the strategic plan. Data used to develop the strategy may include a combination of user's own profile data, data entered by the user, as well as profile data of one or more other users sharing similar profile characteristics and/or attributes as said user. In some aspects, the user and/or one or more of the other users may not have a prior relationship and/or interactions with the platform 110. In other words, establishing an account or prior relationship with the entity that is providing/managing the platform 110 is not required to use and leverage aspects of the platform 110.

The user-personalized strategy developed by the platform 110 may itself be modeled to identify and present the strategy as a combination of ‘bite-sized’ recommendations and/or action item options, together with one or more suggested tools, products, services and/or resources, etc. that may be used in connection with the bite-sized action items for achieving one or more aspects of the user-personalized strategic plan. In some aspects, the bite-sized action items may comprise time-based (e.g., do X this month, then Y next month, etc.) and/or task based (e.g., complete task A before starting task B) actions.

The suggested products, services, tools, resources, etc. may be a part of the platform 110 or made available through one or more externally linked sources. For example, the platform 110 may provide access to and/or make available one or more knowledge databases that are internal to the platform 110, while providing a window and/or link to an external source of data and information in support of the user's strategic plan. Similarly, the platform 110 may provide a link that enables a user to directly contact (e.g., by phone, SMS text, email, etc.,) a system-side user (e.g., advisory professionals) particularly suited to assist the user (e.g., based on the user's profile, plan, action items, etc.).

In some aspects, users may be provided with the option to accept or refuse any of the products, services, tools, resources, etc. suggested/made available by the platform 110; and based on the users' acceptance or refusal input, the platform 110 may be configured to re-execute one or more machine learning algorithms to provide updated suggestions and/or to pause making suggestions for a period of time and/or indefinitely.

As noted above, the user-personalized strategy may be dynamic. Indeed, the platform-developed strategy may be continually updated and revised as a result of completion of tasks, changes to user-defined objectives, user input and/or changes to data that may impact the user's profile and/or suitability of recommended actions, tools, etc. (e.g., change in interest rates, changes to user profiles of other users, updated modeling output, etc.)

The platform 110 may also be configured to intelligently (e.g., using machine learning modeling) suggest and provide access (e.g., based on one or more user interactions within the platform 110 and/or based on user profile data) to one or more community/social networking groups directly from within the platform 110, where members of the community group(s) may share one or more profile characteristics with the user, and/or may benefit (as determined by the platform 110) from interacting with one or more community/social networking groups. Access to such groups enables users to share and display content, comment on content (e.g., liking a post), and communicate in any number of ways (e.g., via text, video, etc.) with other users (e.g., community members, friends, family, etc.).

In some embodiments, the platform 110 may be configured to capture interactions (e.g., dialog, links clicked, in-app purchases made, etc.) within the community groups to continually learn about user(s) tendencies, and based on one or more interactions within the community groups (as well as other data, such as user profile data), the platform 110 may invoke machine learning modeling to analyze the information and/or type of interactions occurring to further suggest (in-person and/or online) events, educational materials, tools, products, etc. to the user and/or one or more other users in group. In some embodiments, the platform 110 may provide links to such materials, tools, etc., which may be stored in one or more databases.

As indicated above, the platform 110 may be configured to continually and/or periodically monitor and capture user interaction data, user activity (e.g., with accounts inside and outside of platform 110), user interactions within social networks, changes to user-related data captured and/or updated by external data sources, changes to user-profile data, etc., to continually learn about each user and to generate alerts, predictions, insights, and/or suggestions responsive to any changes in data or modeling output. As changes occur and/or in response to any of the data/information, so too may the alerts, suggestions, predictions, user-personalized plan, etc. to reflect those changes. For example, upon detecting a change in the monitored data and information, the machine learning modeling engine 122 may re-execute one or more machine learning models, and use the output to dynamically update and display (e.g., via an interactive GUI) the alerts, predictions, insights, etc.

The platform 110 may further be configured to automatically generate and deliver alerts, suggestions, predictions, etc. via any available communications means (e.g., SMS text, email, etc.), even when the user is not actively interacting with the platform 110.

In some aspects, the platform 110 may further provide simulation functionality, which enables the user to test certain actions and/or strategic plans (e.g., initiating and enacting certain tools, products, etc.), and in response, the platform 110 may generate and/or update simulated options and recommendations based on the user's simulated interactions. In this manner, the platform 110 enables the user to consider and evaluate various options and their respective simulated outcomes. The user may then elect to exit the simulation functionality and actually initiate one or more of the tested actions and/or strategic plans.

In some aspects, the platform 110 may be configured to offer rewards that may be utilized to unlock and/or at least partially pay for features and functions of the platform 110 (e.g., tools, products, etc.) that may be utilized to achieve recommended bite-sized actions.

Turning now to FIGS. 2A-2D, exemplary screens 200a, 200b, 200c, 200d of an exemplary interactive GUI 200 according to the present disclosure are shown. As described herein, an interactive GUI according to the present disclosure may comprise a dynamic arrangement of one or more regions, each region providing respective functionality and/or displaying respective data and information. For example, an interactive GUI may comprise one or more user input regions (e.g., for receiving user input), one or more notification/indication(s) regions (e.g., for displaying actionable alerts), one or more display regions (e.g., for displaying data and information from one or more data sources), and one or more community interaction regions (e.g., for initiating community interactions with one or more community members). In some examples, one or more portions of interactive GUI may be automatically updated (including in real-time or near real-time) responsive to changes in user input, machine learning modeling output, changes in monitored data, evolving user tendencies/preferences as determined by one or more machine learning models, etc. The interactive GUI may also be configured to permit and prompt user input (e.g., in a user input region), which in turn may automatically cause information being displayed on the interactive GUI to be updated, as described herein.

Turning now to FIG. 2A, an exemplary dashboard screen 200a of the interactive GUI 200 is shown. In this example, the dashboard screen 200a shows a welcome dashboard, although other types of dashboards are anticipated. In some embodiments, the welcome dashboard 200a may be presented to a user (e.g., via a user device 104) upon the user accessing the platform 110 via a cloud service and/or by launching a software application downloaded onto the user's device. As shown, this dashboard screen 200a comprises several dedicated regions. A first region includes a drop down menu 202 that, upon being selected, displays a list of available/selectable features and functions available through the interactive GUI 200. A second region on this dashboard screen 200a includes selectable icons 210, each configured to initiate one or more tools and resources available via the interactive GUI 200 upon being selected. In some examples, the tools and resources may be user-specific, according to the user's profile, strategic plan, subscription level, etc. As a result, more or fewer tools and resources icons 210 may be displayed and/or available.

In this example, both the dropdown menu 202 and the tools/resources icons 210 may be persistent, meaning that they may remain visible and/or actionable across other screens 200b-200d of the interactive GUI 200. Additional, fewer or other aspects of the interactive GUI 200 may also be persistent.

In this example, the user is a returning user (“Victoria”). As a result, launching and/or opening the welcome dashboard screen 200a causes the interactive GUI 200 to display (and/or update) a summary of user-specific data and information, which may include the user's current account balance 206, an alert of rewards earned 207, an inquiry option 208 (which may enable the user to engage with an intelligent (artificial intelligence) chat-box) and options for initiating one or more additional features and functions 209. In addition, this welcome dashboard screen 200a includes a notification region for displaying/updating notice(s) 204 for the user. Additional or alternative data and information may be displayed on a user's welcome dashboard screen 200a. In some embodiments, a user may select and arrange the data and information being displayed on this welcome dashboard screen 200a. And in some embodiments, the platform 110 may execute (or re-execute) one or more machine learning models to determine, based on usage, importance or any other parameter, which data and information is displayed, as well as the arrangement, size and location (on the screen 200a) of their display.

As described above, each of the notice(s) 204, financial-related data 206, earned rewards 207, inquiry option 208 features/functions 209, and the tools and resources 210 (and any other information displayed on this screen 200a or any other screens of the interactive GUI 200) may be dynamic, insofar as the information displayed and/or the availability thereof may be dynamically updated based on output of one or more machine learning models. For example, the amount of interest displayed 206 may be dynamically updated to reflect real-time interest rate changes, the earned rewards 207 may be dynamically updated to reflect current user-interaction activity with the interactive GUI 200 and/or the platform 110, as well as user-activity with one or more of external data sources 102 (e.g., deposits to a banking account). As the user engages in certain activities (e.g., with the external data sources 102), as the user interacts with the platform 110 (e.g., including by launching this welcome dashboard screen 200a), and/or as any of the data and information relevant to the user changes, the platform 110 may execute (or re-execute) one or more machine learning models whose output may be used to dynamically update the information, features, functions, tools, resources, etc. displayed on and/or available through the interactive GUI 200.

Returning now to the selectable tools/resources icons 210, selecting any one may update a current screen or launch another screen of the interactive GUI 200. For example, selecting the ‘Financials’ icon 210a may cause the interactive GUI 200 to display financial-related data and information on a ‘Financials’ screen 200b, and to initiate one or more updates to the data and information being displayed therein. That is, selecting this icon 210a may cause the platform 110 to execute (or re-execute) one or more machine learning models, the output of which may result in updates to the data and information being displayed.

In this example, the Financials screen 200b illustrates a live/historical analysis of the user's financial profile 214, as well selectable icons 212 that enable the user to access elements or data linked to the user's financial profile. In this example, the selectable icons include a spending icon 212a, a savings icon 212b, a borrowing icon 212c and an investing icon 212d, although other combinations of icons may also be included. This screen also provides a suggested workshop 215 for the user. As noted above, the information displayed on this screen may be dynamic, and updated based on modeling output of one or more of the platform's 110 machine learning models.

Selecting the ‘Community’ icon 210c may cause the interactive GUI 200 to display a Community screen 200c, which includes community-related information and suggested community interaction options as determined by the platform 110 (e.g., via machine learning modeling) and made available to the user. In this example, the Community screen 200c includes a survey 216, a multi-tab region 222 that includes the suggested community interaction options as selectable icons 222a-d on one tab (i.e., Discover 218), and on the second tab (Your Communities 220), communities to which the user has already joined and/or selected to join may be displayed (not shown, may also be selectable icons).

The survey 216 may include inquiries developed by the platform 110, via one or more machine learning models, to obtain more (relevant) information about the user. This survey questions may change over time as determined by the platform 110.

Selection of one or more of the community-related icons 222a-d shown on this screen 200c may connect the user to the selected community group, where the user may engage in live interactions with one or more community members. In some embodiments, a live community window may appear on the screen 200c for engaging in the live community interactions.

The Community screen 200c may also include one or more ‘Events’ icons 224 that alert the user as to one or more available community events. Selecting any of the Events icons 224 may display more details and information about the selected event.

Selecting the ‘Advisor’ icon 210d may cause the interactive GUI 200 to display an

Advisor screen 200d, which may connect the user with a live interaction with a platform-side user, as recommended by the platform 110. In this example, the Advisor screen 200d may include an interaction region 226, which includes an area for displaying the live images of the platform-side user 226a, and an area for displaying live images of the user 226b. When launched, the user and platform-side user may engage in a live video interaction. In addition, or alternatively, the user may utilize the ‘chat’ 226c option, which enables the user to communicate (live) with the platform-side user via text-messaging, for example. Interactions between the user and the platform-side user on the Advisor screen 200d may be facilitated by the platform 110

This Advisor screen 200d may also include data and information 228 that may be accessed and/or referenced during the live interaction, such as user goals and objectives, user's original financial picture, user's personalized recommendations and strategies (e.g., as determined by the platform 110) and so on. As with other screens displayed by the interactive GUI 200, the data, information, features, functions, etc. on this Advisor screen 200d may be updated dynamic based on modeling output of one or more of the platform's 110 machine learning models.

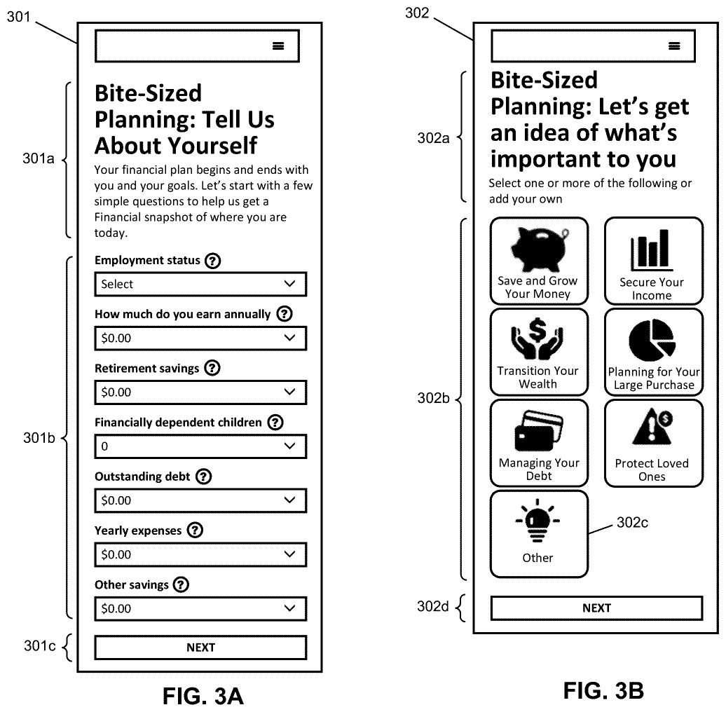

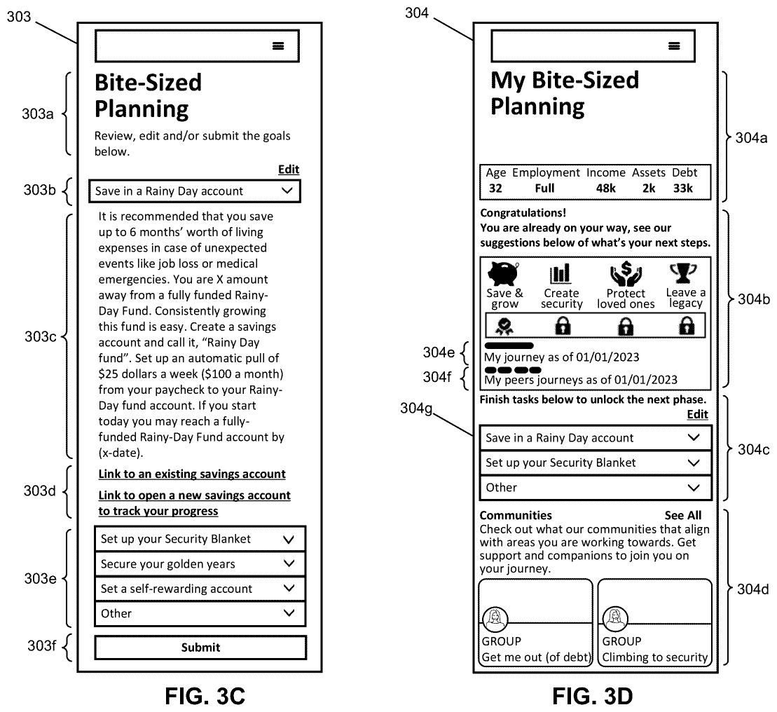

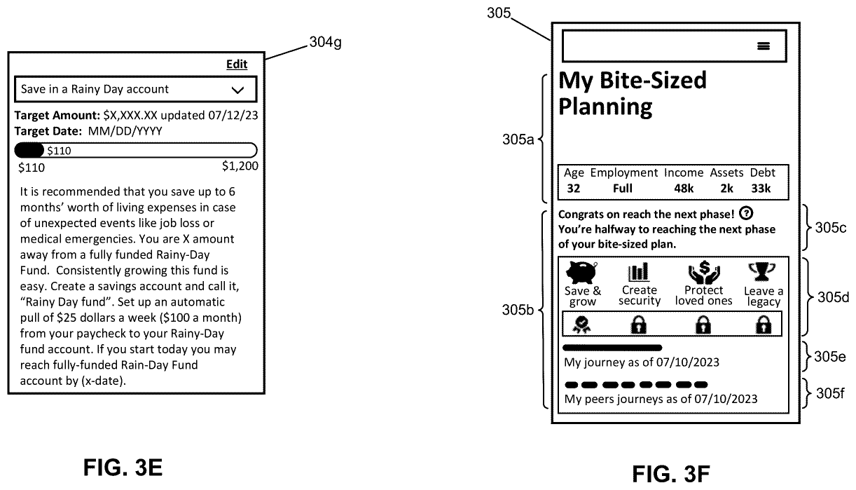

Selecting the ‘Plan’ icon 210b may cause the interactive GUI 200 to display a series of screens that lead the user through a user experience (UX) or journey for creating, retrieving and/or updating and improving a user-personalized strategy. An example of such a journey (or aspects thereof) is further described below with reference to FIG. 3.

Turning now to FIGS. 3A-3F, a series of exemplary interactive GUI screens 301-305 associated with a user experience (UX) according to the present disclosure are shown. Collectively, the interactive GUI screens 301-305 depict aspects of a user's journey for creating and/or progressing through a user-personalized strategy. In other embodiments, a user's journey may involve more, fewer and/or alternative interactive GUI screens.

As shown in FIG. 3A, a first interactive GUI screen 301 may include an introductory/advisory banner 301a to help guide the user through a planning journey, as well as a series of prompts (e.g., drop down menus) 301b configured to collect data and information associated with the user's financial position. The data and information may include, for example, the user's employment status, annual salary, retirement savings, outstanding debt, yearly expenses, and so on. Other types of financial data and information may also be collected. Once collected, the user may proceed to a next interactive GUI screen 302 by selecting a navigation prompt (e.g., ‘Next’) 301c.

FIG. 3B also shows the second interactive GUI screen 302 in this exemplary planning journey. This screen 302 may similarly include an introductory/advisory banner 302a, as well as options for selecting the type of objectives 302b that should be built in to the user's personalized strategy. In this example, the objectives 302b are represented by a number of selectable prompts, each for informing development of the user's personalized strategy. For example, selecting a “Save and Grow Your Money” objective may result in a user-personalized strategy comprising a first set of ‘bite-sized’ action items, whereas selecting a “Managing Your Debt” objective may involve a different set of ‘bite-sized’ action items. In this example, the user is given an ‘Other’ option, which enables the user to define a user-specific objective. Once the one or more objectives 302b are selected, the user may proceed along the planning journey by selecting this screen's ‘Next’ navigation prompt 302d.

Having selected one or more objectives 302b, a third interactive GUI screen 303 may display one or more suggested goals 303b, 303e that may advance one or more of the user's objectives, as shown in FIG. 3C. This screen 303 may also include an introductory/advisory banner 303a to inform the user that the suggested goals may be reviewed, edited and/or submitted.

Selecting one or more of the suggested goals 303b, 303e may provide further guidance and instructions, as well as provide actionable features for reviewing, editing and/or furthering the respective goal. For example, selecting the ‘Save in a Rainy Day Account’ goal 303b may provide a user with further information and suggestions as to how much should be saved in such an account, and provides suggestions on how to achieve such savings (e.g., $100/month) 303c. One or more actionable links may also be presented 303d to enable the user to link to an existing account or open a new account in furtherance of this ‘Save in a Rainy Day Account’ goal 303b.

Once the user has reviewed and/or edited one or more of the suggested goals 303b, 303e, and/or has created a user-defined goal (e.g., by selecting and editing the ‘Other’ prompt), the user may submit the goal(s) 303b, 303e by selecting the ‘Submit’ navigation prompt 303f. Submitting the goals 303b, 303e may in turn cause the platform of the present disclosure to generate and/or update a user-personalized strategy.

FIG. 3D also shows a next interactive GUI screen 304 in the user's planning journey. This screen 304 may include an introductory/advisory banner 304a that summarizes certain attributes of the user's financial profile, such as the user's age, employment status, annual income, assets and debt. This screen 304 may also display phases 304b of the user's personalized strategy, tasks 304c (e.g., bite-sized action items) to complete to unlock (e.g., make available or actionable) a subsequent phase 304b of the user's personalized strategy, and one or more suggested community groups 304d that the user may join.

In this example, the phases 304b portion of the screen 304 depicts the user's personalized strategy as a columniation of four phases 304b: Save & Grow, Create Security, Protect Loved Ones and Leave a legacy. Completing one phase enables the user to advance to a subsequent phase. In some embodiments, a user's personalized strategy may comprise more or fewer phases 304b. Also depicted in this portion of the screen 304 is a comparison between the user's progress 304e through the user's personalized strategy and the progress of one or more peers 304f through their respective personalized strategies. Peers may include other users sharing one or more similar profiles and/or attributes. Displaying this comparison enables the user to visually recognize his/her relative progress in the context of other (comparable) users.

The tasks portion 304c provides a lists of tasks or task categories that, if completed, enable the user to advance through a current phase 304b and progress to a next phase 304b in the user's personalize strategy. Selecting a respective task prompt 304c reveals details of that particular task. As described above, each of these tasks 304c may comprise one or more bite-sized action items. For example, selecting task prompt 304g may reveal details of that particular task, as illustrated in FIG. 3E. FIG. 3E depicts an excerpt of screen 304 that includes an expanded ‘Save in a Rainy Day Account’ task prompt 304g′. As shown, details of this task, such as the user's progress in accomplishing this task and an estimated completion date, are revealed.

The suggested community groups 304d may be selected (e.g., by the platform of this disclosure) for comprising members that have one or more characteristics, interests, tendencies, etc. in common with the user, and/or in response to one or more determinations that (notwithstanding having common characteristics, interests, etc.) the user may benefit from involvement in and/or interactions with the suggested community groups 304d, as discussed above.

Upon completing all tasks associated with a particular phase 304b, the user may progress to a next phase, as noted above. Progressing to a next phase may result in one or more updates to screen 304 and/or display of a new screen to reflect the progress. FIG. 3F, for example, shows interactive GUI screen 305 as a portion of screen 304 that has been updated to reflect the user's accomplishment of a first phase of the user's personalized strategy. This interactive GUI screen 305 includes an introductory/advisory banner 305a similar to the one shown on screen 304. However, the phases 305b portion of this screen 305 now reflects that the user has completed the ‘Save and grow’ phase, and has advanced to the ‘Create security’ phase. This is shown by a congratulatory message 305c (“Congratulations on reaching the next phase!”), a symbol showing that the next phase is now active 305d, and updates to the user's progress bar 305e and to the comparative progress of peers 305f. This screen 305 may include other features and functions, as described herein.

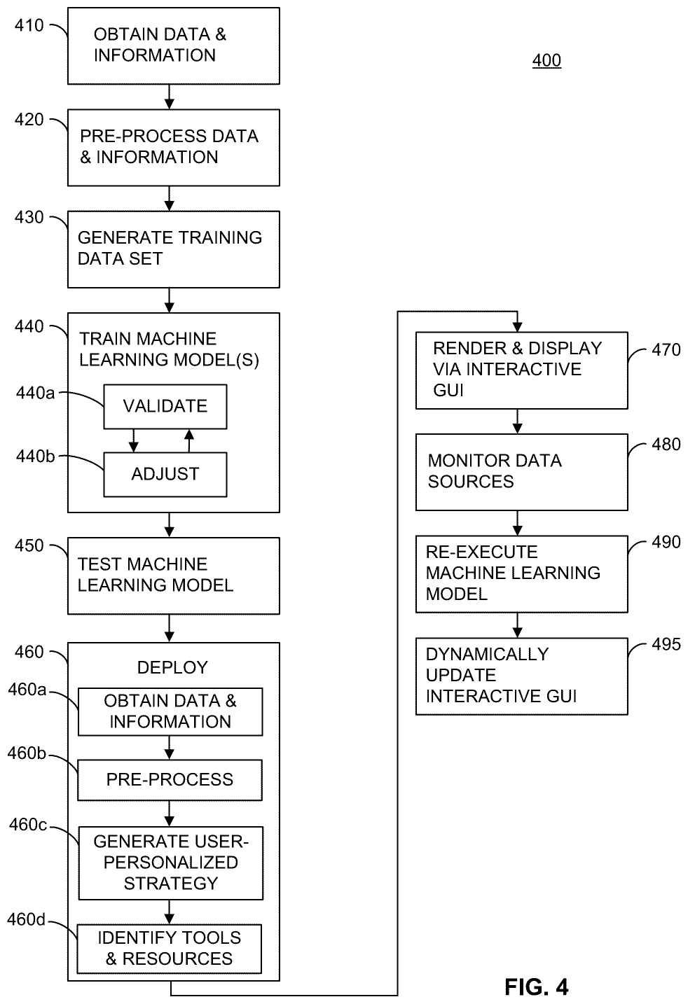

Turning now to FIG. 4, an exemplary method 400 according to one or more embodiments of the present disclosure is shown. The exemplary method 400 pertains to training and deploying one or more machine learning models, and it may be implemented by one or more systems/components described herein, such as the platform 110 of FIG. 1. For purposes of this example, the method 400 will be described in the context of training and deploying one machine learning model. However, it should be understood that the method 400 may be adapted to train and/or deploy (e.g., execute) multiple and/or interrelated machine learning models. As a result, multiple instances of this method 400 may be carried out in parallel and/or sequentially, as needed to achieve various objectives. In addition, portions of this method 400 may be leveraged across multiple machine learning models, to as to reduce redundancy and improve efficiency. For example, aspects of the collecting and pre-processing certain data sets (Steps 410-420), discussed below, may be utilized across multiple machine learning algorithms, particularly if the machine learning models depend on the same or substantially the same type of data for training.

At step 410, the platform 110 may obtain (e.g., collect, receive, extract, retrieve, etc.) historical and/or current (real-time) data and information from one or more data sources (e.g., external data systems 102, user devices 104, data monitor engine 118, platform storage 120, etc.). The data and information may also include modeling output generated by one or more other machine learning models. The types of data and information collected may include user profile data of one or more users, prior user-personalized strategies, user interaction data, user behavioral activity data, account data, market data, and other relevant data and information.

As step 420, the data and information may then be pre-processed, which may include removing noise (e.g., duplicates, corrupted data, etc.), resolving missing data values, filtering, normalizing, scaling and/or augment the data and information (e.g., to add labels and additional data types), and other pre-processing functions.

Once the data and information is pre-processed, the method 400 may proceed to step 430, which may include generating a training data set. In some embodiments, generating a training data set 430 may include splitting the pre-processed data and information into multiple data sets, a portion of which may be used as a training data set. Other portions of the pre-processed data and information may then be utilized to validate and/or test the machine learning model prior to its deployment.

Next, at step 440, the method 400 may include training the machine learning model. This step may include solving one or more objective functions of the machine learning model. The one or more objective functions may include one or more parameters (e.g., weight), that may be adjusted until an acceptable level of convergence is obtained.

During the training step 440, the method 400 may include, as step 440a, validating the machine learning model. Validating the machine learning model 440a may include measuring how the trained machine learning model performs based on a validation data set. The validation data set may comprise a portion of the data and information that was pre-processed during step 420. The performance of the machine learning model may be measured using one or more performance metrics such as, for example, accuracy, profit, or any other relevant measure of success. If the measured performance is unsatisfactory, one or more of the parameters may be adjusted at step 440b and the performance re-measured. This process may be iterative and continue until the performance is deemed satisfactory (e.g., meets or exceeds the one or more performance metrics).

Following the training step 440, the method 400 may proceed to step 450, where the machine learning model may be tested. The testing step 450 may include, for example, applying the trained machine learning model to a simulated environment and/or to a data set that hasn't be ‘seen’ by the machine learning model, and measuring its effectiveness against one or more scenarios.

Upon satisfactorily completing the testing step 450, the machine learning model may be deployed at step 460 to generate, retrieve and/or dynamically update and improve user-personalized strategies, user profiles, alerts, predictions, automated decision making, recommendations (e.g., as to tools, resources, community interactions, etc.), user-personalized content and information (e.g., from one or more data sources) and so on. Deploying the machine learning model 460 may include, at step 460a, obtaining (e.g., collecting, receiving, extracting, retrieving, etc.) historical and/or current (real-time) data and information for use as input to the machine learning model. The input may be obtained from one or more data sources (e.g., external data systems 102, user devices 104, data monitor engine 118, platform storage 120, output from one or more machine learning models, user input, etc.).

Next, at step 460b, the input may be pre-processed to remove noise (e.g., duplicates, corrupted data, etc.), resolve missing data values, filter, normalize, scale, and/or augment data included in the input, and the like.

At step 460c, the machine learning model may then generate, based on the input, a user-personalized strategy, and at step 460d, identify one or more tools and resources for completing one or more aspects of the user-personalized strategy. In some embodiments, step 460c may be carried out by one or more other machine learning models, which may be deployed in concert with the instant machine learning model, using the user-personalized strategy generated at step 460c as input.

The user-personalized strategy (from step 460c) and the one or more tools and resources (from step 460d) may then be rendered and displayed via an interactive GUI at step 470, to enable a user to interact with aspects of the user-personalized strategy and utilize one or more of the tools and resources.

During steps 460 and 470, or at some point thereafter, the method 400 may proceed step 480. Step 480 may include monitoring one or more data sources, including sources of the input to the machine learning model, for changes, updates, additions, etc. to data and information that may impact determinations and suggestions of the machine learning model. This may include, for example, monitoring the user's interaction(s) with the user-personalized strategy (from step 460c) and the one or more tools and resources (from step 460d) via the interactive GUI.

Responsive to the monitoring step 480, the method 400 may re-execute the machine learning model at step 490, to account for changes, updates, additions, etc. to the monitored data and information. In some embodiments, the re-execution step 490 may be triggered if the changes, updates, additions, etc. meet or exceed one or more predetermined criteria.

Next, at step 495, the method 400 may include dynamically updating the interactive

GUI to display changes to the user-personalized strategy and the one or more tools and resources resulting from the re-execute step 490. The method 400 may then return to step 480 and steps 480-495 may be repeated in a loop for a predetermined number of times, for a predetermined period of time, for a predetermined number of loops, until the user-personalized strategy is completed or otherwise terminated, or until the method 400 is terminated (e.g., by the platform 110).

In an exemplary embodiment, a system according to the present disclosure may include a platform comprising one or more servers that each includes one or more processors and a memory storing computer-readable instructions that, when executed by the one or more processors, cause the platform to perform certain operations. The system may also include one or more storage devices accessible by the platform, for storing historic and real-time data and information, machine learning modeling output, data submitted to the platform (e.g., via an interactive GUI), etc. The platform may be in communication with one or more user devices and one or more external data systems via one or more communication networks. The user devices may access and interact with the platform via a software application downloaded onto the user device(s), and/or by accessing the platform online as one or more cloud-based subscription services.

The operations may include generating and training one or more machine learning models, and receiving, from among the one or more external data systems and the one or more user devices, data and information relating to a plurality of users. The data and information may include a combination of historic and real-time data and information, data submitted by a user device (e.g., via an interactive GUI) in response to one or more platform generated prompts and questions, as well as modeling output generated by at least one among the machine learning models.

Once received, the data and information may then be converted into a format that is suitable for use by one or more machine learning models. The operations may also include executing the one or more machine learning models using the converted data and information as input. In response, the machine learning models may generate a user-personalized strategy and identify tools and resources for completing aspects of the user-personalized strategy.

The operations may include presenting the user-personalized strategy as a compilation of bite-sized action items, some of which may be time-based action items and some of which may be task-based action items. In that case, the tools and resources identified may correspond to one or more of the bite-sized action items. In some examples, completion, expiration and/or rejection of one or more of the bite-sized action items may cause the platform to re-execute one or more machine learning models, and update a remainder of the bite-sized action items. The operations may also include locking and/or unlocking the tools and resources according to a subscription level of a user.

The operations may further include generating an interactive GUI that displays the user-personalized strategy and the tools and resources for completing aspects of the user-personalized strategy. The interactive GUI may be transmitted to the user devices for rendering and display thereon, or the platform may render the GUI and transmit the rendered GUI to the user devices for display thereon.

Further still, the operations may include monitoring at least one among the one or more external data systems and the user device for changes to the data and information, re-executing one or more machine learning models responsive to the monitored data and information, and dynamically updating the interactive GUI to display changes to the user-personalized strategy and the tools and resources resulting from the re-executing. In some examples, the re-executing operation(s) may be triggered if the monitored data and information meets or exceeds one or more predetermined parameters, and in some examples, the re-executing operation(s) may be initiated according to one or more predefined schedules.

The monitoring operation(s) may also include monitoring and capturing interaction data, utilizing the interaction data as input to the machine learning models and re-executing the machine learning models responsive to the interaction data. Interaction data may include data defining one or more user interactions made between user devices and the platform. In some examples, the operations may include generating and offering rewards based the interaction data, progression through the user-personalized strategy, and/or utilization of the one or more tools and resources. Such rewards may be used to unlock access to one or more features and functions of the platform.

In some examples, the interaction data may include community interaction data, which includes data defining user interactions in connection with one or more online community networking groups. In those cases, the operations may include generating one or more community interaction groups and activities.

In some examples, the community interaction data may include conversations, messages, clicked links, user reaction indications, user posts, and/or user commentary associated with one or more members of one or more online community networking groups. The online community networking groups may be accessible via the interactive GUI, simultaneously with the user-personalized strategy and the tools and resources for completing the one or more aspects of the user-personalized strategy. During a live community interaction, the operations may include capturing live community interaction data, re-executing one or more machine learning models using the live community interaction data as input, and dynamically updating the user-personalized strategy and the one or more tools and resources based on modeling output generated by the re-executed machine learning models.

The operations may also include retrieving, from one or more data sources, user-personalized information and content based on modeling output from the machine learning models, and displaying the user-personalized information and content, simultaneously with the user-personalized strategy and the one or more tools and resources via the interactive GUI. The interactive GUI may include multiple dedicated display regions, such as one or more user input regions, one or more notification regions, one or more display regions, and/or one or more community interaction regions.

Further, the operations may include generating, simultaneously displaying and dynamically updating one or more alerts, predictions, insights, suggestions, community groups activities, and forecasts based on modeling output from the machine learning models. The operations may also include generating and transmitting user-personalized strategies, alerts, predictions, insights, suggestions, community groups activities, and/or forecasts to the user devices via one or more communication means.

The operations may also include evaluating a performance of the machine learning models over time based on one or more performance metrics and updating and/or re-training at least one machine learning model based on the evaluating. In some examples, performance of the machine learning models may include a measure of accuracy, user sentiment and a utilization associated with the user-personalized strategy, the tools and resources, and/or the alerts, predictions, insights, suggestions, community groups activities, and forecasts generated by the platform.

In an exemplary embodiment, a method according to the present disclosure may be implemented by a system comprising a platform that comprises one or more servers that each includes one or more processors and a memory storing computer-readable instructions that, when executed by the one or more processors, cause the platform to perform the method. The system may also include one or more storage devices accessible by the platform, for storing historic and real-time data and information, machine learning modeling output, data submitted to the platform (e.g., via an interactive GUI), etc. The platform may be in communication with one or more user devices and one or more external data systems via one or more communication networks. The user devices may access and interact with the platform via a software application downloaded onto the user device(s), and/or by accessing the platform online as one or more cloud-based subscription services.

The method may include generating and training one or more machine learning models, and receiving, from among the one or more external data systems and the one or more user devices, data and information relating to a plurality of users. The data and information may include a combination of historic and real-time data and information, data submitted by a user device (e.g., via an interactive GUI) in response to one or more platform generated prompts and questions, as well as modeling output generated by at least one among the machine learning models.

Once the data and information is received, the method may include converting the data and information into a format that is suitable for use by one or more machine learning models. The method may also include executing the one or more machine learning models using the converted data and information as input. In response, the method may include generating (e.g., by the machine learning models) a user-personalized strategy and identifying tools and resources for completing aspects of the user-personalized strategy.

The method may include presenting the user-personalized strategy as a compilation of bite-sized action items, some of which may be time-based action items and some of which may be task-based action items. In that case, the tools and resources identified may correspond to one or more of the bite-sized action items. In some examples, completion, expiration and/or rejection of one or more of the bite-sized action items may cause the method to include re-executing one or more machine learning models, and updating a remainder of the bite-sized action items. The method may also include locking and/or unlocking the tools and resources according to a subscription level of a user.

The method may further include generating an interactive GUI that displays the user-personalized strategy and the tools and resources for completing aspects of the user-personalized strategy, and transmitting the interactive GUI to the user devices for rendering and display thereon. Alternatively or additionally, the method may include rendering the interactive GUI at the platform and transmitting the rendered GUI to the user devices for display thereon.

Further still, the method may include monitoring at least one among the one or more external data systems and the user device for changes to the data and information, re-executing one or more machine learning models responsive to the monitored data and information, and dynamically updating the interactive GUI to display changes to the user-personalized strategy and the tools and resources resulting from the re-executing. In some examples, the re-executing step(s) may be triggered if the monitored data and information meets or exceeds one or more predetermined parameters, and in some examples, the re-executing step(s) may be initiated according to one or more predefined schedules.

The monitoring step(s) may also include monitoring and capturing interaction data, utilizing the interaction data as input to the machine learning models and re-executing the machine learning models responsive to the interaction data. Interaction data may include data defining one or more user interactions made between user devices and the platform. In some examples, the method may include generating and offering rewards based the interaction data, progression through the user-personalized strategy, and/or utilization of the one or more tools and resources. Such rewards may be used to unlock access to one or more features and functions of the platform.

In some examples, the interaction data may include community interaction data, which includes data defining user interactions in connection with one or more online community networking groups. In those cases, the method may include generating one or more community interaction groups and activities.

The community interaction data may include conversations, messages, clicked links, user reaction indications, user posts, and/or user commentary associated with one or more members of one or more online community networking groups. The method may include providing access to the online community networking groups via the interactive GUI, simultaneously with the user-personalized strategy and the tools and resources for completing the one or more aspects of the user-personalized strategy. During a live community interaction, the method may include capturing live community interaction data, re-executing one or more machine learning models using the live community interaction data as input, and dynamically updating the user-personalized strategy and the one or more tools and resources based on modeling output generated by the re-executed machine learning models.

The method may also include retrieving, from one or more data sources, user-personalized information and content based on modeling output from the machine learning models, and displaying the user-personalized information and content, simultaneously with the user-personalized strategy and the one or more tools and resources via the interactive GUI. The interactive GUI may include multiple dedicated display regions, such as one or more user input regions, one or more notification regions, one or more display regions, and/or one or more community interaction regions.

Further, the method may include generating, simultaneously displaying and dynamically updating one or more alerts, predictions, insights, suggestions, community groups activities, and forecasts based on modeling output from the machine learning models. The method may also include generating and transmitting user-personalized strategies, alerts, predictions, insights, suggestions, community groups activities, and/or forecasts to the user devices via one or more communication means.

In addition, the method may include evaluating a performance of the machine learning models over time based on one or more performance metrics, and updating and/or re-training at least one machine learning model based on the evaluating. In some examples, performance of the machine learning models may include a measure of accuracy, user sentiment and a utilization associated with the user-personalized strategy, the tools and resources, and/or the alerts, predictions, insights, suggestions, community groups activities, and forecasts generated by the platform.

In some embodiments, a computer program product is disclosed herein. The computer program product may include computer-readable instructions that, when executed by one or more processors, cause a computer system to perform any of the operations and methods described herein.

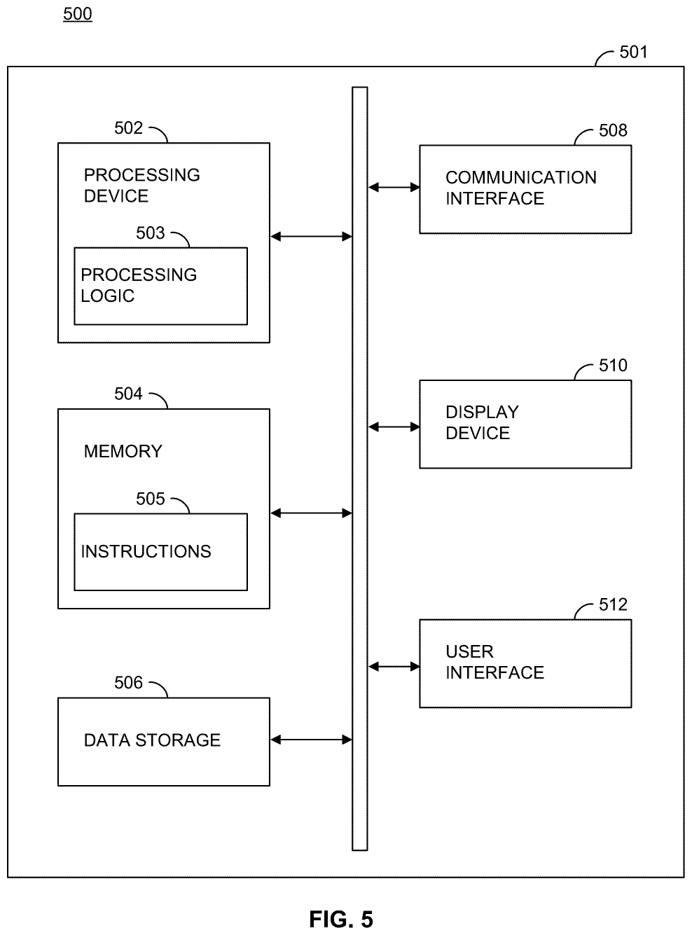

FIG. 5 illustrates a functional block diagram 500 of an exemplary machine 501 within which a set of instructions for causing the machine 501 to perform any one or more of the methodologies, processes or functions discussed herein may be executed. In some examples, the machine 501 may be connected (e.g., networked) to other machines as described above. The machine 501 may operate in the capacity of a server or a client machine in a client-server network environment, or as a peer machine in a peer-to-peer (or distributed) network environment. The machine 501 may be any special-purpose machine capable of executing a set of instructions (sequential or otherwise) that specify actions to be taken by that machine 501 for performing the functions describe herein. Further, while only a single machine 501 is illustrated, the term “machine” shall also be taken to include any collection of machines that individually or jointly execute a set (or multiple sets) of instructions to perform any one or more of the methodologies and/or to provide any of the features and functions discussed herein. In some examples, the platform 110 described herein (and/or one or more of its components) may comprise one or more specialized machines 501, such as the example shown in FIG. 5, where each of said specialized machines 501 may be particularly programmed to perform certain methodologies, features and/or functions described herein.

The example machine 501 of FIG. 5 may include a processing device 502, memory 504, a data storage device 506 and a communication interface 508, which may communicate with each other via a data and control bus. In some examples, the machine 501 may also include a display device 510 and/or a user interface 512. The processing device 502 may include a microprocessor, a central processing unit, an application-specific integrated circuit (ASIC), a field programmable gate array (FPGA), a digital signal processor (DSP) and/or a network processor, and it may be configured to execute processing logic 503 for performing the operations described herein.

Machine memory 504 may include, for example, at least one of a read-only memory (ROM), a random-access memory (RAM), a flash memory, a dynamic RAM (DRAM) and a static RAM (SRAM), storing computer-readable instructions 505 executable by the processing device 502. The memory 504 may include a non-transitory computer readable storage medium storing computer-readable instructions 505 executable by the processing device 502 for performing the operations described herein. Although one memory device 504 is illustrated in FIG. 5, in some examples, the exemplary machine 501 may include multiple memory devices 504 (e.g., dynamic memory and static memory).

The exemplary machine 501 of FIG. 5 may further include a communication interface device 508 for communicating with other computers (including wired and/or wireless communication) and/or for communication with a network. In some examples, the exemplary machine 501 may include display device 510 (e.g., a liquid crystal display (LCD), a touch sensitive display, etc.) and/or a user interface 512 (e.g., an alphanumeric input device, a cursor control device, etc.).

In some examples, the machine 501 of FIG. 5 may include a data storage 506 device storing instructions (e.g., software) for performing any one or more of the functions described herein. The data storage device 506 may include a non-transitory computer-readable storage medium, including, without being limited to, solid-state memories, optical media and magnetic media.

Systems and methods of the present disclosure may include and/or may be implemented by one or more specialized computers including specialized hardware and/or software components. For purposes of this disclosure, a specialized computer may be a programmable machine capable of performing arithmetic and/or logical operations and specially programmed to perform the functions described herein. In some embodiments, computers may comprise processors, memories, data storage devices, and/or other components. These components may be connected physically or through network or wireless links. Computers may also comprise software which may direct the operations of the aforementioned components. Computers may be referred to as servers, personal computers (PCs), mobile devices, and other terms for computing/communication devices. For purposes of this disclosure, those terms used herein are interchangeable, and any special purpose computer particularly configured for performing the described functions may be used.

Computers may be linked to one another via one or more networks. A network may be any plurality of completely or partially interconnected computers wherein some or all of the computers are able to communicate with one another. Connections between computers may be wired in some cases (e.g., via wired TCP connection or other wired connection) or may be wireless (e.g., via a WiFi network connection). Any connection through which at least two computers may exchange data can be the basis of a network. Furthermore, separate networks may be able to be interconnected such that one or more computers within one network may communicate with one or more computers in another network. In such a case, the plurality of separate networks may optionally be considered to be a single network.

The term “computer” shall refer to any electronic device or devices, including those having capabilities to be utilized in connection with an electronic information/transaction system, such as any device capable of receiving, transmitting, processing and/or using data and information. The computer may comprise a server, a processor, a microprocessor, a personal computer, such as a laptop, palm PC, desktop or workstation, a network server, a mainframe, an electronic wired or wireless device, such as for example, a telephone, a cellular telephone, a personal digital assistant, a smartphone, an interactive television, such as for example, a television adapted to be connected to the Internet or an electronic device adapted for use with a television, an electronic pager or any other computing and/or communication device.

The term “network” shall refer to any type of network or networks, including those capable of being utilized in connection with the systems and methods described herein, such as, for example, any public and/or private networks, including, for instance, the Internet, an intranet, or an extranet, any wired or wireless networks or combinations thereof.

The term “computer-readable storage medium” should be taken to include a single medium or multiple media that store one or more sets of instructions. The term “computer-readable storage medium” shall also be taken to include any medium that is capable of storing or encoding a set of instructions for execution by the machine and that causes the machine to perform any one or more of the methodologies of the present disclosure.

While the present disclosure has been discussed in terms of certain embodiments, it should be appreciated that the present disclosure is not so limited. The embodiments are explained herein by way of example, and there are numerous modifications, variations and other embodiments that may be employed that would still be within the scope of the present disclosure.

1. A system comprising:
one or more user devices;
one or more external data systems; and
a platform in communication with the one or more user devices and the one or more external data systems via one or more communication networks,
the platform comprising one or more servers, the one or more servers comprising one or more processors and a memory storing computer-readable instructions that, when executed by the one or more processors, cause the platform to:
generate and train one or more machine learning models;
receive, from among the one or more external data systems and the one or more user devices, data and information relating to a plurality of users;
convert the data and information into a format that is suitable for use by one or more machine learning models;
execute the one or more machine learning models using the converted data and information as input, the one or more machine learning models configured to:
generate, for at least one among the plurality of users, a user-personalized strategy, and
identify one or more tools and resources for completing one or more aspects of the user-personalized strategy;
generate an interactive graphical user interface (GUI) that displays the user-personalized strategy and the one or more tools and resources for completing the one or more aspects of the user-personalized strategy;
monitor at least one among the one or more external data systems and the one or more user device for changes to the data and information;
re-execute the one or more machine learning models responsive to the monitored data and information; and
dynamically update the interactive GUI to display changes to the user-personalized strategy and the one or more tools and resources resulting from said re-execute.

2. The system of claim 1, wherein the data and information comprises a combination of historic and real-time data and information, and wherein the input to the one or more machine learning models comprises modeling output generated by at least one among the one or more machine learning models.

3. The system of claim 2, wherein the data and information further comprises data submitted by at least one among the user devices via the interactive GUI in response to one or more platform-generated prompts and questions.

4. The system of claim 3, further comprising one or more storage devices accessible by the platform, the one or more storage devices storing the historic and real-time data and information, the machine learning modeling output, and the data submitted via the interactive GUI.

5. The system of claim 1, wherein at least one among the one or more user devices accesses and interacts with the platform via a software application downloaded onto the at least one user device.

6. The system of claim 1, wherein at least one among the one or more user devices accesses and interacts with the platform online as one or more cloud-based subscription services.

7. The system of claim 1, wherein the platform is further configured to:
determine that the monitored data and information meets or exceeds one or more predetermined parameters; and
re-execute the one or more machine learning models based on said determination.

8. The system of claim 1, wherein the platform is further configured to:
monitor and capture interaction data;
utilize the interaction data as input to the one or more machine learning models; and
re-execute the one or more machine learning models responsive to the interaction data,
the interaction data defining one or more user interactions made between the one or more user devices and the platform.

9. The system of claim 8, wherein the interaction data comprises community interaction data, and wherein the one or more machine learning models are configured to generate one or more community interaction groups and activities,
the community interaction data defining user interactions in connection with one or more online community networking groups.

10. The system of claim 9, wherein the community interaction data comprises one or more of conversations, messages, clicked links, user reaction indications, user posts, and user commentary associated with one or more members of the one or more online community networking groups.

11. The system of claim 9, wherein the one or more online community networking groups are accessible via the interactive GUI, simultaneously with the user-personalized strategy and the one or more tools and resources for completing the one or more aspects of the user-personalized strategy.

12. The system of claim 9, wherein during a live community interaction, the platform captures live community interaction data, re-executes the one or more machine learning models using the live community interaction data as input, and dynamically updates the user-personalized strategy and the one or more tools and resources based on modeling output generated by the re-executed one or more machine learning models.

13. The system of claim 1, wherein the platform is further configured to retrieve, from one or more data sources among the external data systems, user-personalized information and content based on modeling output from the one or more machine learning models, and wherein the interactive GUI displays the user-personalized information and content, simultaneously with the user-personalized strategy and the one or more tools and resources.

14. The system of claim 1, wherein the interactive GUI comprises a plurality of dedicated display regions comprising a combination of one or more user input regions, one or more notification regions, one or more display regions, and one or more community interaction regions.

15. The system of claim 1, wherein the platform is further configured to generate, simultaneously display and dynamically update one or more alerts, predictions, insights, suggestions, community groups activities, and forecasts based on modeling output from the one or more machine learning models.

16. The system of claim 15, wherein the platform configured to generate and transmit one or more of the user-personalized strategy, alerts, predictions, insights, suggestions, community groups activities, and forecasts to the one or more user devices via one or more communication means.

17. The system of claim 1, wherein the user-personalized strategy is presented as a compilation of a plurality of bite-sized action items, and wherein each of the one or more tools and resources corresponds to one or more of the bite-sized action items.

18. The system of claim 16, wherein the bite-sized action items comprise a combination of time-based action items and task-based action items.

19. The system of claim 17, wherein at least one of completion, expiration and rejection of one or more among the plurality of bite-sized action items causes the platform to re-execute the one or more machine learning models, and update a remainder of the plurality of the bite-sized action items.

20. The system of claim 1, wherein the platform is configured to re-execute the one or more machine learning models according to one or more pre-determined schedules.

21. The system of claim 1, wherein the platform is configured to lock and unlock the one or more tools and resources according to a subscription level of a user.

22. The system of claim 8, wherein the platform is configured to generate and offer rewards, based on one or more of the interaction data, progression through the user-personalized strategy, and utilization of the one or more tools and resources,
said rewards configured to unlock access to one or more features and functions of the platform.

23. The system of claim 1, wherein the platform is configured to:
evaluate a performance of the one or more machine learning models over time based on one or more performance metrics; and
at least one of update and re-train at least one among the one or more machine learning models based on said evaluate.

24. The system of claim 23, wherein the performance of the one or more machine learning models comprises at least one of a measure of accuracy, user sentiment and a utilization associated with one or more of the user-personalized strategy, the one or more tools and resources, and one or more of the alerts, predictions, insights, suggestions, community groups activities, and forecasts generated by the platform.

25. The system of claim 1, wherein the platform is configured to transmit the interactive GUI to one or more user devices for rendering and display thereon.

26. The system of claim 1, wherein the platform is configured to render the GUI at said platform, and transmit the rendered GUI to one or more user devices for display thereon.
